(19) United States
(12) Patent Application Publication
(10) Pub. No.: US 2021/0095385 A1
(43) Pub. Date: Apr. 1, 2021

(54) HIERARCHICAL WRINKLE FILM FOR THE CATALYTIC REDUCTION OF CARBON DIOXIDE

(71) Applicants: Saudi Arabian Oil Company, Dhahran (SA); Korea Advanced Institute Science and Technology, Daejeon (KR)

(72) Inventors: Issam Gereige, Thuwal (SA); Hee-Tae Jung, Daejeon (KR); Kyeong Min Cho, Daejeon (KR); Woo-Bin Jung, Daejeon (KR)

(21) Appl. No.: 16/588,549

(22) Filed: Sep. 30, 2019

(51) Int. Cl. C25B 11/04; C25B 11/02; C25B 3/04

(52) U.S. Cl. CPC C25B 11/0473; B01J 23/52; C25B 3/04; C25B 11/02

(57) ABSTRACT

A method of fabricating a working electrode adapted for reduction of carbon dioxide comprises layering a gold film (Au) over a shrinkable polymer to create a layered structure, heating the layered structure to cause shrinking, for instance, at a temperature of about 130° C., and removing the shrinkable polymer layer. The heating creates a contracted, wrinkled Au film surface owing to a difference in thermal coefficient between the Au film and the underlaying polymer prior to removal of the polymer, and the wrinkled film contains c-shaped wrinkles containing confined spaces in which a local elevated pH level is attained.

### FIELD OF THE DISCLOSURE

The present disclosure relates to catalytic chemistry, and, more particularly, relates to a method for fabricating hierarchically-wrinkled structures bearing a gold catalyst for the reduction of carbon dioxide.

### BACKGROUND OF THE DISCLOSURE

The electrocatalytic reduction of carbon dioxide (CO₂) into carbon-based fuels or valuable chemicals using renewable electricity demonstrates promise for the utilization of captured CO₂ and for the long-term storage of renewable energy. In particular, the reduction of CO₂ into carbon monoxide (CO) is the initial step for obtaining more complex carbon products, and it provides insight into the mechanism of the CO₂ reduction reaction (CO₂RR) due to the simple two-electron pathway. However, CO₂RR suffers from low selectivity at low overpotential due to the competitive hydrogen evolution reaction (HER) in aqueous media.

Several structural catalyst parameters including its nanostructure, surface morphology, and surface area are thought to be important for improving the catalytic activity for CO₂RR. The shape and aspect ratio of catalyst nanoparticles can contribute to high current density and Faradaic efficiency. Faradaic efficiency is a measure of the efficiency of charge transfer in an electrochemical reaction. Losses in Faradaic efficiency occur when electrons or ions participate in side reactions. Increasing catalyst surface area and the density of grain boundaries through changes in surface morphology also provides effective reaction sites for reduction to occur.

In addition, some studies have suggested that the pH near the electrode is a factor that can be controlled to improve the selectivity of CO₂RR. While the kinetics of reduction of CO₂ into CO is independent of the pH, high pH suppresses the HER due to the slow kinetics of proton adsorption, which is the rate-determining step of HER. Accordingly, selective CO₂RR can be achieved by the inhibition of HER. However, the extent to which the local pH improves the selectivity of CO₂RR has not been sufficiently investigated.

It would therefore be advantageous to provide a method of structuring a catalyst in which local pH can be tuned to enhance the selectivity and Faradaic efficiency of the CO₂RR. The present disclosure addresses these and other needs in the art.

### SUMMARY OF THE DISCLOSURE

Embodiments disclosed herein includes a method of fabricating a working electrode adapted for reduction of carbon dioxide. The method comprises depositing a gold film (Au) over a shrinkable polymer to create a layered structure, heating the layered structure sufficient to cause shrinkage of the polymer layer and removing the polymer layer after shrinkage. The heating creates a contracted wrinkled Au film surface owing to a difference in thermal coefficient between the Au film and the underlaying polymer prior to removal of the polymer. The wrinkled film contains a plurality of c-shaped wrinkles having confined spaces adapted to provide an elevated localized pH level.

In at least one embodiment, the heating step comprises heating the layered structure at a temperature of about 130° C. in order to cause shrinkage of the polymer layer.

In certain embodiments, the method further comprises controlling a period of the heating step to tune an areal strain (ε=(A₀−A_{f})/A₀)) in which A₀ is a total area of the Au film prior to wrinkling and A_{f} is a total area of the Au film after contraction. The period of heating can be set to produce an areal strain of about 0.5 to about 0.75.

In certain embodiments, the method further comprising forming the Au film over the polymer at a thickness level to set a desired average depth of the plurality of c-shaped wrinkles. The Au film is formed at thickness ranging from about 75 nm to about 100 nm.

Additional embodiments of the fabrication method comprise forming needle nanostructures from Au on and within the plurality of c-shaped wrinkles of the gold film.

Further embodiments of the fabrication method comprise before heating, forming an additional sacrificial layer to increase depths of the confined spaces in the plurality of c-shaped wrinkles, and removing the sacrificial layer. The additional sacrificial can be formed at between about 4 wt % and about 8 wt % of the layered structure.

The disclosure further provides a method of reducing carbon dioxide comprising constructing an electrochemical cell containing an electrolyte, a counter electrode and a working electrode formed as a wrinkled Au film containing a plurality of c-shaped wrinkles in c-shaped wrinkles containing confined spaces adapted to provide an elevated localized elevated pH level, and applying a potential difference across the working electrode and the counter electrode ranging between about −0.25 and about −0.65 Volts, wherein the potential difference induces a carbon dioxide reduction reaction at the working electrode and to cause the pH level within the confined spaces of the plurality of c-wrinkles to become elevated with respect to a surrounding pH level.

In certain embodiments, the Au film of the working electrode has a thickness of about 75 nm to about 100 nm. The plurality of c-shaped wrinkles can have an average depth range from about 1.8 μm to about 4.2 μm.

In some implementations, the working electrode has a Faraday efficiency for reducing carbon dioxide of at least 65 percent and can induce a current density for the carbon dioxide reduction reaction of at least 0.05 mA/cm².

In additional embodiments, the Au film of working electrode further includes a plurality of needle nanostructures, the plurality of nanostructure having a length ranging from about 700 nm to about 900 nm. In some implementations, the working electrode with added needle nanostructures induces a current density of the carbon dioxide reduction reaction of at least 0.45 mA/cm².

Also disclosed herein is a system for reducing carbon dioxide comprising an electrolyte, a counter electrode in contact with the electrolyte, a working electrode also in contact with the electrolyte, the working electrode formed as a wrinkled Au film containing a plurality of c-shaped wrinkles in c-shaped wrinkles containing confined spaces adapted to provide an elevated localized pH level, and a voltage source coupled to the counter electrode and working electrode and adapted to generate a potential difference ranging between about −0.25 and about −0.65 Volts therebetween, which induces a carbon dioxide reduction reaction at the working electrode and to cause the pH level within the confined spaces of the plurality of c-wrinkles to become elevated with respect to a surrounding pH level.

These and other aspects, features, and advantages can be appreciated from the following description of certain embodiments of the invention and the accompanying drawing figures and claims.

### BRIEF DESCRIPTION OF THE DRAWINGS

The patent of application file contains at least one drawing executed in color. Copies of this patent or patent application publication with color drawings(s) will be provided by the Office upon request and payment of the necessary fee.

FIG. 1A is a schematic illustration of a method of fabricating a confined wrinkle structure according to an embodiment of the present disclosure.

FIG. 1B is an exemplary scanning electron microscopy (SEM) image of c-wrinkles on wrinkled gold film fabricated according to the method of the present disclosure.

FIG. 1C is a magnified view of a portion of the SEM image of FIG. 1B.

FIG. 1D is a side view of the magnified SEM image of FIG. 1C.

FIG. 2A is a schematic illustration with accompanying SEM images showing changed in a wrinkled Au film as areal strain (E) is varied.

FIG. 2B is a graph depicting the Faraday efficiency (FE) of the CO₂ to CO reaction on the wrinkled Au film versus applied voltage.

FIG. 2C is a graph depicting the current densities, J_{CO} (left panel), J_{H2} (right panel) versus applied voltage at the different ε values.

FIG. 2D is a schematic illustration showing changes in a wrinkled Au film as film thickness is varied from 25 nm up to 100 nm.

FIG. 2E is a graph of the Faraday efficiency (FE) of the CO₂ to CO reaction on the occurring wrinkled Au film versus applied voltage at the different thickness levels.

FIG. 2F is a graph depicting the current densities, J_{CO} (left panel), J_{H2} (right panel) versus applied voltage at different thickness (t) values.

FIG. 3A is a graph depicting FE_{CO} versus applied voltage at different strains at a constant thickness.

FIG. 3B are plan and cross-sectional SEM images of Au wrinkled films at different ε at a constant Au film thickness.

FIG. 3C is a schematic illustration of the variation of confined spaces in the c-wrinkles of an Au film according to different weight percentages of a sacrificial skin layer, with accompanying SEM images.

FIG. 3D is a graph depicting both the Faraday efficiency of the CO₂RR and depth of confined wrinkles versus PVP sacrificial skin layer concentration (C_{PVP}).

FIG. 3E is a schematic illustration of chemical kinetics at the wrinkled Au film with o-wrinkles.

FIG. 3F is a schematic illustration of chemical kinetics at the wrinkled Au film with c-wrinkles.

FIG. 4A illustrates FEA analyses of how OH⁻ ions concentrate at flat surface, o-shaped wrinkle and c-shaped wrinkle geometries.

FIG. 4B is a histogram of maximum OH⁻ concentration for each of the geometries shown in FIG. 4A.

FIG. 4C illustrates modeled changes in OH⁻ concentration within the c-wrinkle geometry over time.

FIG. 4D is a histogram graph depicting OH⁻ concentration at several depths within the c-wrinkle.

FIG. 5A schematically illustrates a process in which starting from a wrinkled Au film 502, needle nanostructures are deposited on the wrinkles 504

FIG. 5B includes SEM images of example needle nanostructures at 3 μm (first panel) and 200 nm (second panel) scales.

FIG. 5C depicts a histogram of Faraday efficiency versus potential and a graph of current density over time for the Au film with needle nano structures.

### DESCRIPTION OF CERTAIN EMBODIMENTS OF THE DISCLOSURE

Disclosed herein is a method of obtaining highly selective electrocatalytic CO formation (e.g., 90% of FE_{CO} at −0.4 V) using a catalyst fabricated with confined wrinkles. The confined wrinkles in the catalyst provide microenvironments in which regions of localized pH form. The confined wrinkles (referred to as “c-wrinkles” herein) are fabricated via the difference in the thermal shrinkage coefficient between a gold skin layer and a polymer (e.g., polystyrene (PS)) substrate. Electrocatalytic reduction tests with systematically controlled wrinkle structures and electrochemical analysis demonstrate that the selectivity of the reaction is primarily related to elevated local pH and is less related to changes in other parameters such as specific surface area, surface morphology, surface composition, and nanostructure. In addition, finite element analysis (FEA) simulations demonstrate that confined microwells in the c-wrinkles are effective structures for generating high localized pH via the accumulation of hydroxide ions which are a by-product of the CO₂ reduction and hydrogen evolution reactions.

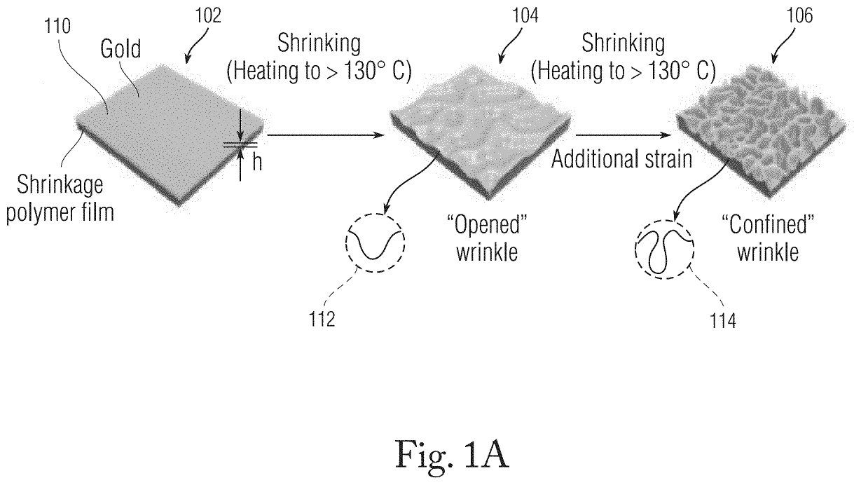

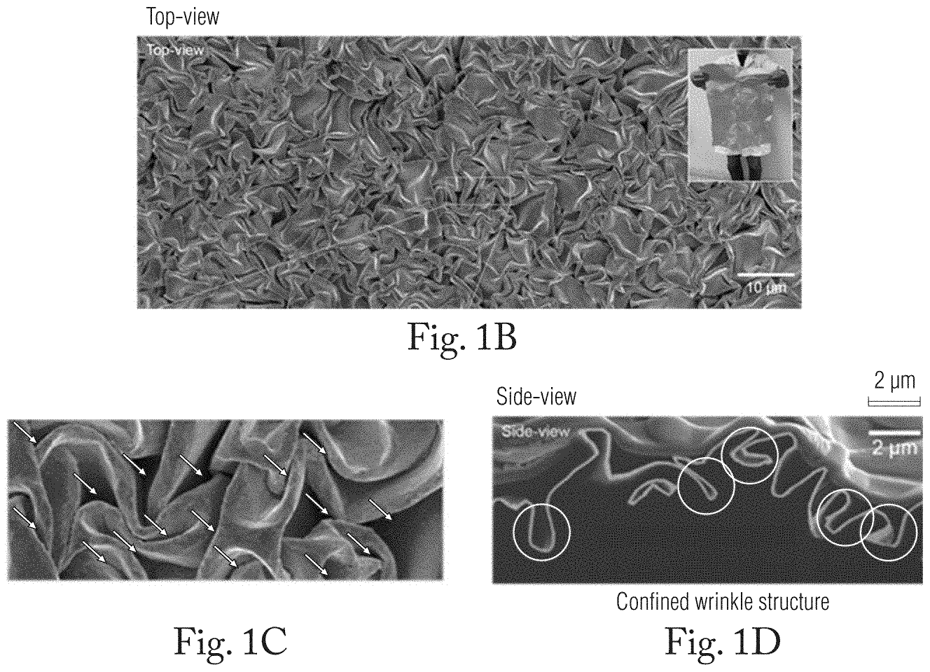

FIG. 1A is a schematic illustration of a method of fabricating a confined wrinkle structure according to an embodiment of the present disclosure. In a first step 102 a thin Au film 110 is deposited on a polystyrene substrate (shrinkage file) by e-beam evaporation. It is noted that other substrates and additional layers can be used in other embodiments. In a following step 104, the structure is heated above the glass transition temperature (T_{g}) of the polystyrene film (˜120° C.). An areal strain parameter is defined as ε=(A₀−A_{f})/A₀), in which A₀ and A_{f} denote the areas before and after strain relief, respectively. This parameter can be controlled by modifying the length of heating time. When a short heating time is used, o-shaped wrinkles 112 with a small curvature and accessible surface are formed. In step 106, heating continues above the glass transition temperature (135° C.). The structure is cooled to room temperature afterwards. As shown in FIG. 1A, as the strain is on the films is increased, c-shaped wrinkles 114 with larger curvatures are formed.

In the method described above, the c-wrinkles are part of valleys formed within the wrinkle structure. Wrinkling is typically a physical bottom-up, convenient method for generating confined spaces on a large area in a reproducible manner. Conventional methods such as the etching of sacrificial polymer particles, and wet anodization at high potential, are energy-inefficient processes, with limitations in terms of scalability for mass-production. In contrast, the Au-wrinkle fabrication disclosed herein can be used to fabricate confined wrinkled structures over a large are (e.g., >2,000 cm²) in a short time (e.g., 3-5 minutes).

To fabricate multiscale hierarchical wrinkles containing opened wrinkles, an additional process was employed following the initial formation of the wrinkled Au film. The structure is embedded into polyvinylpyrrolidone (PVP), which serves as a sacrificial skin layer. Then, the embedded wrinkle is heated at greater than 130° C. to generate microscale additional wrinkles without confined morphology. After a subsequent third wrinkle generation process, confined wrinkles are not observed even at a high strain level of 0.75.

FIG. 1B shows an exemplary scanning electron microscopy (SEM) image of c-wrinkles on wrinkled gold film. Randomly distributed c-wrinkles are formed over a large area. The transition from o-wrinkles to c-wrinkles occurs when the mismatch of compressive strain between the skin and bulk substrate reach a critical value. A portion of FIG. 1B, bounded by the box 120, is shown in the magnified plan view SEM image of FIG. 1C and in the magnified side view shown in FIG. 1D. In FIGS. 1C and 1D, confined cavities within the c-wrinkles are clearly shown. The arrows in FIG. 1C indicate the deep valley of a c-wrinkles, and the circles shown in FIG. 1D indicate that the confined cavities which constitute small openings as viewed from the top surface (FIG. 1C) of the Au film have a confined volume that extends beneath the top surface (FIG. 1D).

Carbon dioxide reduction performance of the wrinkled-Au film in an electrochemical cell was tested at different levels of areal strain (ε) and Au layer thickness (t). The electrode of the cell was prepared by direct connection between the wrinkled film and wire. Copper tape was attached to the connected area, and all of the unutilized surface was covered with a polyimide tape. The electrode size for CO₂ conversion was approximately 0.5 cm². The cell consisted of a cathode and anode, respectively. The two compartments were separated by a Nafion membrane. A Ag/AgCl electrode and Pt wire were used as the reference and counter electrodes, respectively. The wrinkled Au film connected to a wire was used as the working electrode. Electroreduction tests were conducted using 50 mL of the electrolyte with 0.5 M and 0.1 M KHCO₃. Before reaction, nitrogen was introduced for 15 min for degassing, followed by switching to carbon dioxide for 30 min to permit the sufficient dissolution of CO₂. After a 30-min reaction with applied voltage, the gaseous product was measured by gas chromatography.

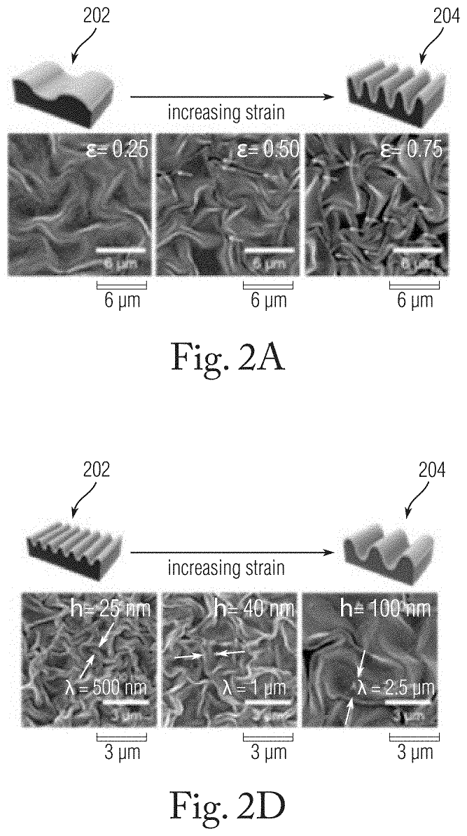

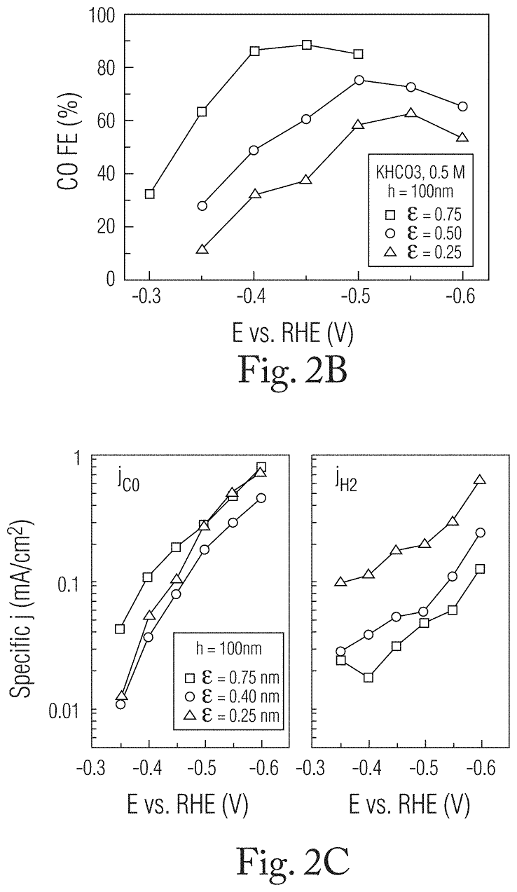

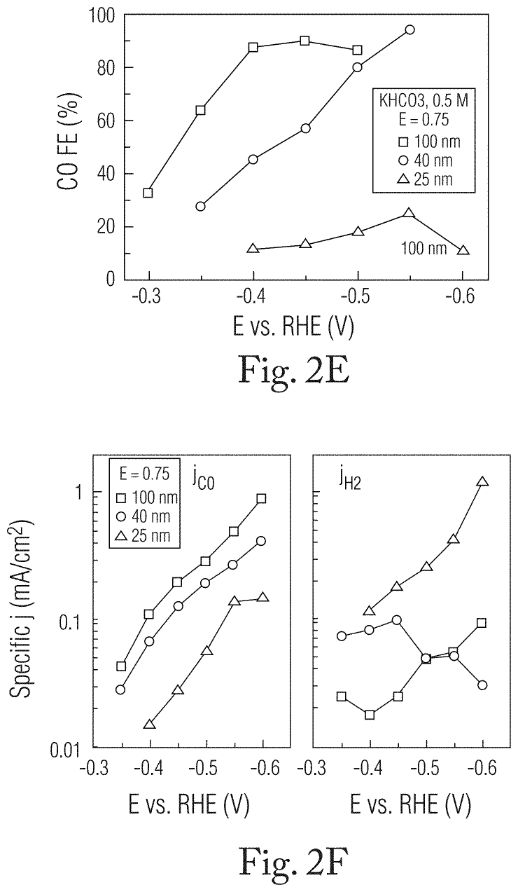

FIG. 2A is a schematic illustration with accompanying SEM images showing a wrinkled film as ε is varied from 0.25 to 0.75 at a t value of 100 nm. At the initial stage of wrinkling 202 (ε=0.25), the Au film forms o-wrinkles with a low amplitude and a completely open surface. As ε increases from 0.25 to 0.5, c-shaped confined cavities can be observed in the wrinkle valley. With a further increase of ε to 0.75 (stage 204 in FIG. 2A), the density of the confined spaces in the c-wrinkles also increases. Electrocatalytic reduction was carried out using three-electrode systems with a CO₂-saturated 0.5 M KHCO₃ electrolyte. Carbon monoxide (CO) and hydrogen (H₂) were the main products on the Au electrode in the applied voltage range. FIG. 2B is a graph depicting the Faraday efficiency (FE) of the CO₂ to CO reaction occurring on the wrinkled Au film versus applied voltage at the different strain levels (ranging from −0.3 V to −0.6 V as measured against a reversible hydrogen electrode (RHE)). In the tests, the Au wrinkle with low ε (ε=0.25, shown by triangles in FIG. 2B) exhibited weak catalytic activity for CO₂RR, with the maximum FE_{CO} reaching 62.4% at −0.55 V. With the increase of ε to 0.5 (shown by circles), a higher FE_{CO} was achieved in the applied voltage range. The maximum FE_{CO} achieved at the ε=0.5 strain level was 75.3% at −0.5 V (vs. RHE). Notably, at the higher strain at which c-wrinkles form prevalently (ε=0.75, shown by squares), significantly improved catalytic activity was achieved, reaching an FE_{CO} of 88.5% at −0.4 V (vs. RHE). Even at a low overpotential of 190 mV (−0.3 V vs. RHE), an FE_{CO} of 32.4% was observed.

The selectivity of the CO₂ reduction reaction depends to an extent on ε and with the formation of confined cavities which from at ε>0.5. The partial current densities of CO and H₂ (J_{CO} and J_{H2}, respectively) were calculated by the multiplication of the total current density and respective faradaic efficiency. FIG. 2C is a graph depicting the current densities, J_{CO} (left panel), J_{H2} (right panel) versus applied voltage at the different ε values. The ε-controlled Au wrinkles at the different strains exhibited similar J_{CO} values at a high applied voltage, and the wrinkled film with ε=0.75 exhibited a higher J_{CO} (0.11 mA/cm²) compared with that of the wrinkled film with ε=0.25 (0.058 mA/cm² at −0.4 V). The wrinkled film with ε values of 0.25 and 0.75 exhibited j_{H2} values of 0.03 and 0.0052 mA/cm², respectively, indicative of a six-fold decrease in H₂ formation with the formation of c-wrinkles. Accordingly, selective CO formation on c-wrinkles at a low overpotential is achieved by the suppression of H₂ formation.

In another set of tests, the effect of the dimensions of the confined cavity of the c-wrinkle on the CO₂ reduction reaction by the variation of the thickness (t) of the c-wrinkle was investigated. Changes in the thickness of the Au film cause corresponding changes in the wavelength (λ) of the wrinkles which conform generally to the relationship between wavelength and skin thickness, λ=2πt(E̅e̅ₛ/3Ē_{b}) (Ē=E/(1−v²)), in which Eₛ and E_{b} denote the moduli of the skin layer and bulk substrate, respectively, and v is Poisson's ratio. FIG. 2D is a schematic illustration with accompanying SEM images showing a wrinkled film as t is increased from 25 nm, in experimental stage 206, up to 100 nm, at experimental stage 208, keeping a constant ε value of 0.75. As t increases from 25 nm to 100 nm with an ε value of 0.75, the wrinkle wavelength λ increases from about 500 nm to about 2.5 μm. The increased wavelength of the wrinkles is associated with greater depths of the confined cavities. FIG. 2E is a graph of the Faraday efficiency (FE) of the CO₂ to CO reaction on the occurring wrinkled Au film versus applied voltage at the different thickness levels. The shallow c-wrinkled film with a thickness t=25 nm exhibited weak CO₂RR activity, with an FE_{CO} of 10%-20%, likely related to the poor contact resistance of the thin Au electrode after wrinkling. At a thickness of 40 nm, the FE_{CO} of the film increased to 27.2% at an onset potential of −0.35 V, reaching 93.1% at −0.55 V. At a thickness of 100 nm a substantial amount of CO was generated at an onset potential of −0.3 V, and an FE_{CO} of 32.4% and a CO selectivity of 85.9% were achieved at −0.4 V. The overpotential at the maximum FE_{CO} shifted by 150 mV relative to that at t=40 nm. The enhanced selectivity performance with higher t demonstrates that large confined spaces positively affect the selectivity of CO₂RR. FIG. 2F is a graph depicting the current densities, J_{CO} (left panel), J_{H2} (right panel) versus applied voltage at the different t values. As shown, the J_{CO} of the c-wrinkled film at t=100 nm was 0.11 mA/cm², which is 1.6 times greater than that (0.068 mA/cm²) of the film with t=40 nm. J_{H2} values at t=100 nm and 40 nm were −0.018 and −0.084 mA/cm², respectively, at −0.4 V (vs. RHE). The experiments show that with increasing t, H2 formation is highly suppressed and is a major causative factor leading to selective CO₂RR.

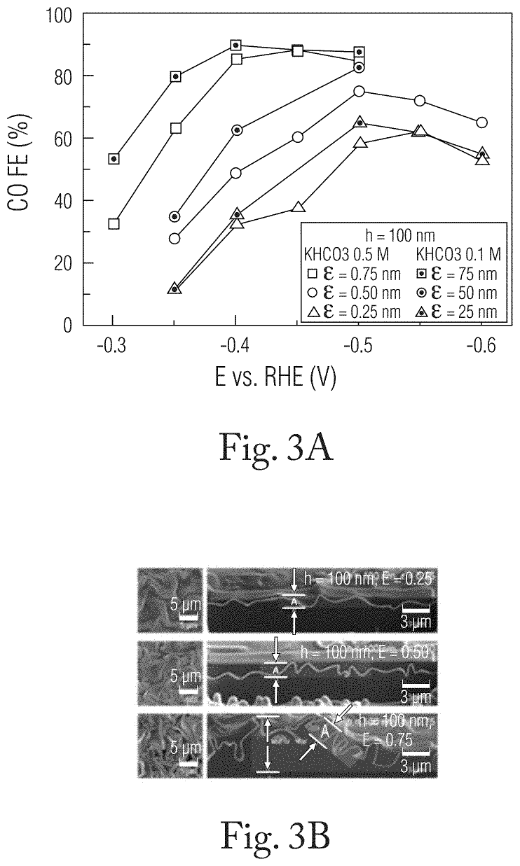

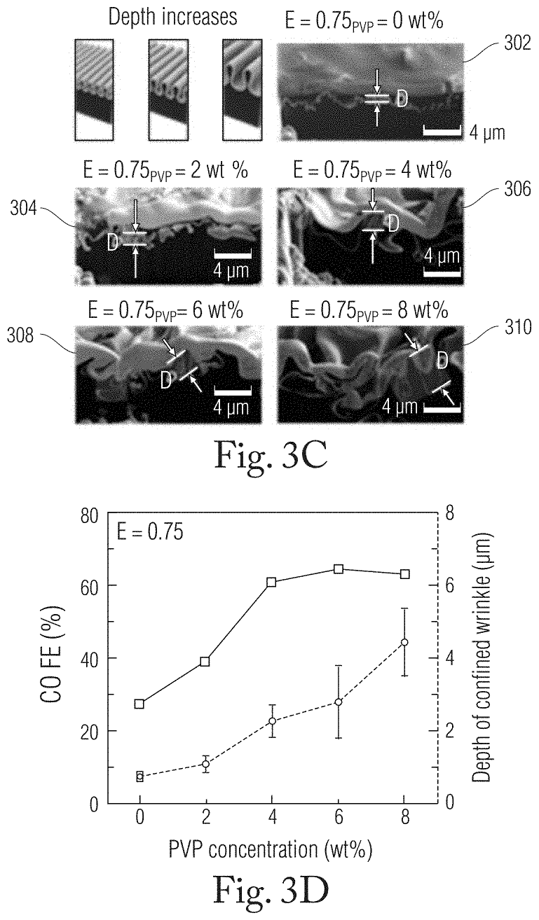

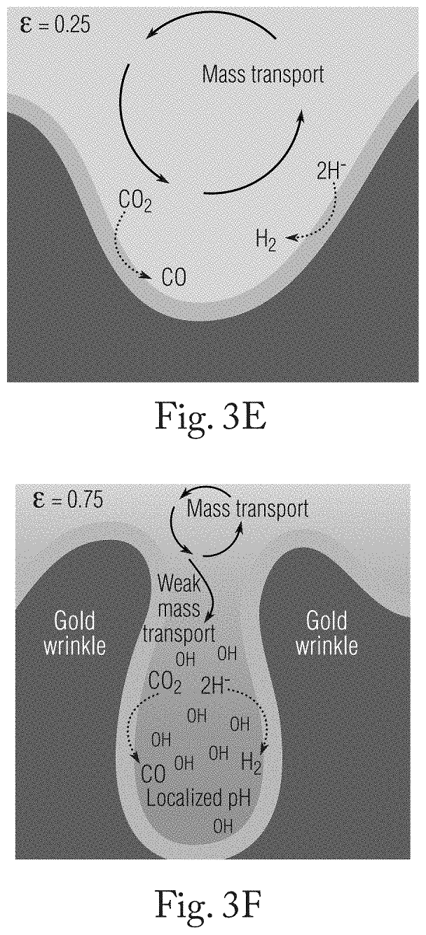

To further investigate and confirm that the local pH of the c-wrinkle is a key parameter for selective CO formation, additional CO₂RR experiments with various confined volumes in the wrinkled film and different electrolytes were conducted. In addition, the effects of the surface lattice, surface area, and strain on the wrinkled film were analyzed. In one test, the CO₂RR was performed with a low electrolyte concentration (0.1 M KHCO₃) to observe the local pH effect. Generally, the localization of pH near the electrode surface grows in a low electrolyte concentration due to the low amount of buffer ions. FIG. 3A is another graph depicting FE_{CO} versus applied voltage at different strains at a constant thickness (t=100 nm). As shown, at −0.4 V vs. RHE the FE_{CO} level at ε=0.50 (shown by circles connected by dashed line) was 53.7% and reached 90.2% at ε=0.75 (shown by squares connected by dashed line). The Faraday efficiency at all strain levels at the low electrolyte concentration was higher than for the corresponding strain levels at higher electrolyte concentration level (shown by the data connected by non-dashed lines). More generally, FE_{CO} shifted upward at higher strain levels, indicative of the selective formation of CO via the increase in the local pH. In contrast, the wrinkled Au film with lower strain (ε=0.25) exhibited a less dramatic change in FE_{CO}.

FIG. 3B shows plan and cross-sectional SEM images of Au wrinkled films at ε values of 0.25, 0.5, and 0.75 at a constant Au film thickness of 100 nm. The wrinkle amplitudes (A, measured from top to bottom) at the three different areal strains are 1.4 μm, 1.7 μm, and 2.1 μm, respectively. As indicated in FIG. 3B, confined volumes in c-wrinkles occur at an ε of 0 and the density of the confined volumes increase at a ε of 0.75. Thus, wrinkles at a high strain have not only large amplitude but also a large volume of confined space. Unexpectedly, although c-wrinkle at lower thicknesses (ε=0.75; t=40 nm) have lower amplitudes, increased selectivity of CO formation was observed, indicative of local pH effect; however, significant changes in FE_{CO} were not observed, even at high amplitudes (A=2.1 μm). Consequently, the generation of confined cavities is thought to be critical in generating high localized pH.

The test results indicated that the nanostructure and surface morphology did not have a significant effect on selective CO₂RR. The surface structure was investigated by the measurement of the electrochemical surface area (ECSA) and surface facets of the wrinkle film. The ECSA was calculated from the peak area for oxygen reduction at 0.85 V (vs. Ag/AgCl), which was estimated by cyclic voltammetry (CV) using 50 mM H₂SO₄. The ECSAs normalized by the geometric surface area were about 1.4 at an ε value of 0.5 and about 1.0 at an ε value of 0.5 and 0.75, respectively. The slight decrease of ECSA revealed a dead surface due to the formation of the c-wrinkles. In other words, surface area, by itself, is not related to the significant enhancement of selective CO₂RR. In addition, the surface lattice of the Au wrinkles was evaluated by the underpotential deposition (UPD) of lead. Lead UPD was conducted by chemical vaporization in 10 mM Pb(CH₃CO2)₂ with 0.1 M H₂SO₄. The Au film exhibited cathodic and anodic peaks corresponding to the deposition and stripping of lead. The Pb deposition peaks at −0.49 and −0.35 V corresponded to the (111) and (100) Au facets, respectively. Regardless of the thickness and strain, Au wrinkles exhibited similar intensity ratios for the two corresponding peaks. Consequently, the surface lattice did not substantially change during the wrinkle film fabrication. According to these results, the surface area and surface lattice are shown to not be the main drivers of enhanced CO₂RR activity. In addition to the surface structure, the activity for CO₂RR is confirmed to not be related to the strain on the surface atoms. When o-wrinkle are fabricated at an ε value of 0.75 by successive, repetitive wrinkling rather than by a single wrinkling process, the resulting CO₂RR activity was similar to that of the o-wrinkle at an ε value of 0.25 despite the high applied strain.

Additional tests were performed to determine the effect of the dimensions of the confined cavity in the c-wrinkles on the localized pH. Polyvinylpyrrolidone (PVP) was introduced as an additional sacrificial skin layer for controlling the depth of the confined cavity while keeping the areal strain ε and thickness t of the Au film constant. After increasing the thickness of the skin layer during wrinkling, the PVP sacrificial layer was removed using ethanol. FIG. 3C schematically illustrates the variation of depth of the confined spaces in the c-wrinkles of an Au film according to the weight percentage (concentration) of the sacrificial skin layer with accompanying SEM images. As the PVP concentration was increased from 0 wt % (302), to about 2 wt % (304), about 4 wt % (306), about 6 wt % (308) to about 8 wt % (310) the depth of the c-wrinkle continuously increased from 0.8, 1.0, 2.0, and 2.5 to 4 μm, respectively. FIG. 3D is a graph depicting both the Faraday efficiency of the CO₂RR and depth of confined wrinkles versus PVP concentration (C_{PVP}) at −0.35 V versus RHE and ε=0.75. The FE_{CO} gradually increases and reaches 60% at a C_{PVP} of 4 wt %, indicating that the volume of the confined space is directly related to the CO₂ electroreduction performance. In addition, the performance is not further enhanced with the increase in the depth of the folding structure to greater than ˜2 μm because a sufficient confined space already exists to induce the localized pH at the 2 μm. The use of the sacrificial layer can then enable selective CO₂ reduction in films fabricated with smaller amounts of Au.

The results obtained from CO₂RR and the cross-sectional analysis conclusively demonstrate that the selective CO formation is caused by localized pH provided by the confined space within the c-wrinkles and not primarily by the amplitude of the o-wrinkles, the high applied strain, or changes in atomically active sites. FIG. 3E is a schematic illustration of chemical kinetics at the wrinkled Au film at a low strain (ε=0.25) surface with o-wrinkles. As shown, the reactants and products are completely accessible near the o-wrinkle surface, similar to a flat Au surface. In contrast, at a high strain surface (ε=0.75) containing c-wrinkles as shown in FIG. 3F, mass diffusion is limited. Hydroxide ions generated by CO₂RR and HER accumulate in the confined spaces, which causes local pH to elevate locally. Generally, hydrogen formation is strongly deactivated at high pH because proton adsorption plays a key role in hydrogen gas evolution; however, the electroreduction of CO₂ is independent of pH, resulting in high selectivity of the CO₂ reduction reaction within the confined microspaces of the c-wrinkles.

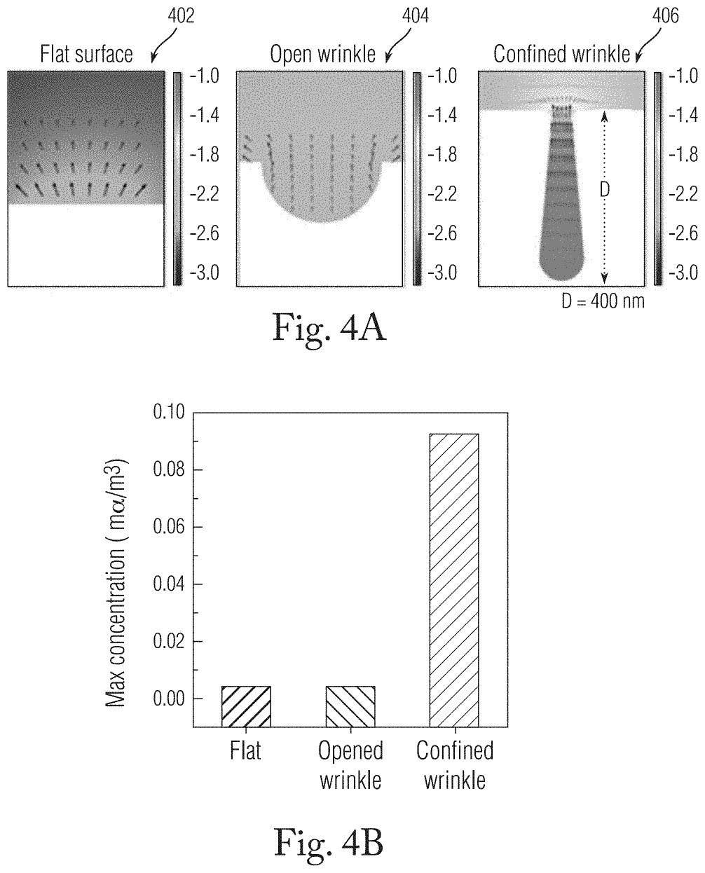

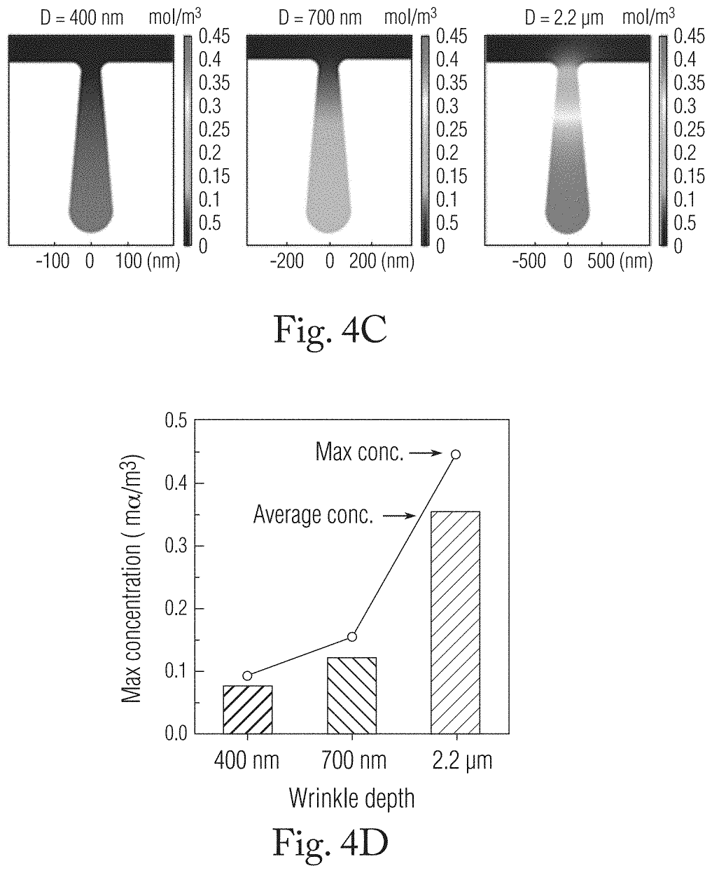

Additional computational tests were performed to further validate the experimentally observations relating the confined spaces on the c-wrinkles to local pH generation. By using two-dimensional finite element analysis (FEA), the OH⁻ concentration for three wrinkle geometries (viz. flat, opened, and confined, respectively) with three size scales (wrinkle depth (D)=400, 700, and 2200 nm, respectively) was analyzed. Two-dimensional FEM simulation was performed with the COMSOL Multiphysics package (COMSOL Multiphysics® v.5.3; COMSOLAB, Stockholm, Sweden). The “Laminar Flow” and “Transport of Diluted Species” modules were used to model the coupled problem of the liquid flow and ion diffusion. To examine the effect of the liquid flow and ionic diffusion on the OH⁻ concentration, the coupled convection-diffusion equation by assuming laminar liquid flow was solved. FIG. 4A illustrates FEA analyses of how OH⁻ ions concentrate at flat surface 402, o-shaped wrinkle 404 and c-shaped wrinkle 406 geometries. FIG. 4B is a histogram of maximum OH− concentration for each of the geometries. As indicated in FIG. 4B, the c-wrinkled geometry exhibited greater a maximum concentration great than 13 times the flat and o-wrinkle geometries.

In the FEA analysis, the external flow of the electrolyte fluid did not affect the transport to the confined space inside of the c-wrinkle geometry. In addition, the concentration of ions in the c-wrinkle geometry remained high as the surface area on which the ions were generated was considerably greater than the area opening to the exterior volume. FIG. 4C illustrates modeled changes in OH⁻ concentration within the c-wrinkle geometry over time, and FIG. 4D is a histogram graph depicting OH⁻ concentration at several depths within the c-wrinkle. Both FIGS. 4C and 4D show that the ion concentration increases with length scale. The characteristic flow sweeping time

over the opening (removal time of ions near the opening), τ, was roughly proportional to

$$\frac{d}{{U}_{0}} , or τ = α \frac{d}{{U}_{0}} ,$$

in which d is the diameter of the opening, U₀ is the far field velocity, and α is a proportionality constant. The diffusion length (∝\sqrt{Dτ}) increased with the square root of the length scale; hence, the absolute scale (the distance from the bottom of the wrinkle to the opening) linearly increases with the length scale, increasing the ion concentration in the case of large wrinkles. With the increase in the wrinkle depth from 400 nm to 2.2 μm, the average and maximum concentrations increased by approximately 4.7 and 4.8 times, respectively. All results for different shapes and sizes supported the local pH effects in the experimental results.

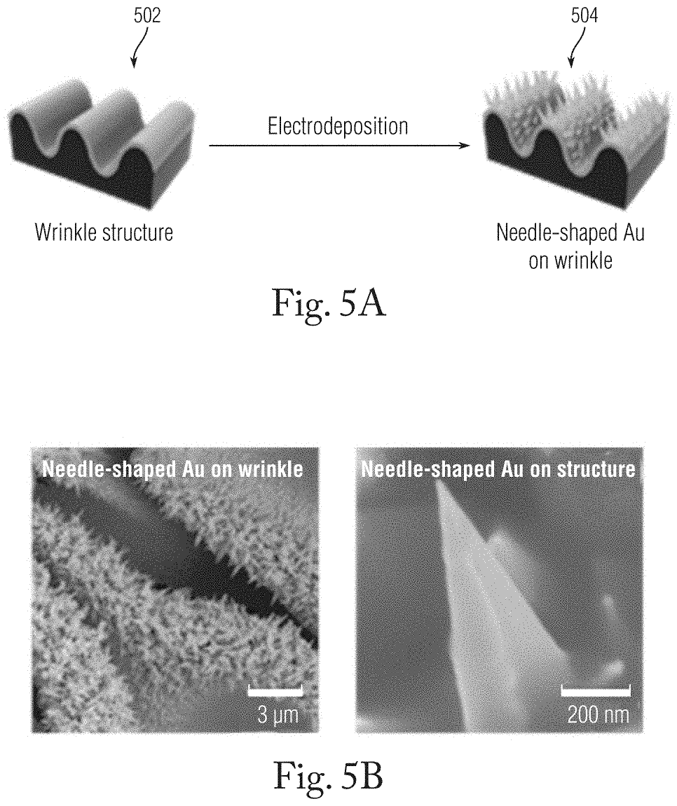

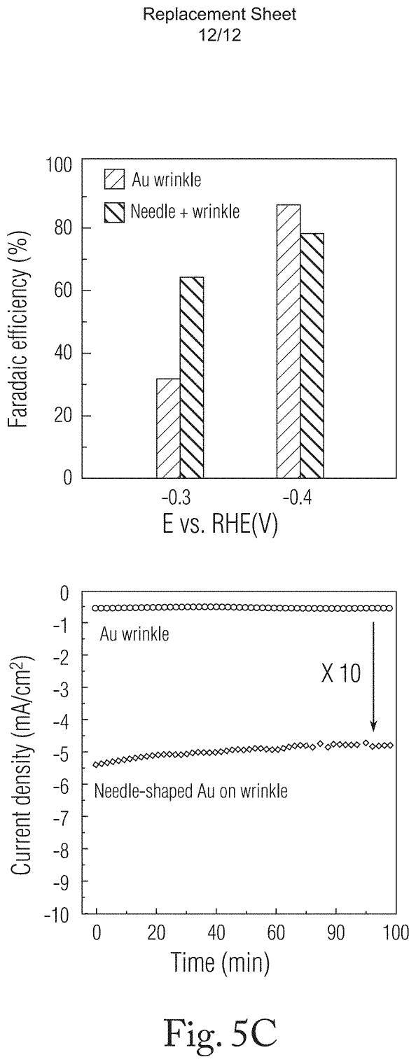

In certain embodiments of the disclosed method, the current density of CO₂RR can be enhanced by incorporating needle-like nanostructures (“needle nanostructures”) onto the c-wrinkles in the Au film. FIG. 5A schematically illustrates a process in which starting from a wrinkled Au film 502, needle nanostructures are deposited on the c-wrinkles 504. The needle nanostructures typically exhibit both a large surface area and selective CO₂RR due to the large amount of cation adsorption resulting from heightened electrical fields at the sharp corners of the nanostructures. To fabricate a dense nanostructure on the confined spaces, an Au film with high-amplitude c-wrinkles was used (4 μm wrinkle amplitude, ε=0.75, t=40 nm, C_{PVP}=8 wt %). The needle nanostructures were electrodeposited on the Au film at −250 mV for 300 s. After electrodeposition, the nanostructures were densely formed on the top of the waves of the surface and in the confined spaces.

FIG. 5B shows SEM images of example needle nanostructures at 3 μm (first panel) and 200 nm (second panel) scales. As shown in the second panel of FIG. 5B in particular, the needle nanostructures have sharp edges and corners with a height of approximately 800 nm. The Au film with the needle nanostructures performed with a high FE_{CO} (˜65%) at low overpotential (−110 mV, −0.3 V vs. RHE). FIG. 5C includes a histogram of Faraday efficiency versus potential and a graph of current density over time for the Au film with needle nanostructures. The highly selective CO₂RR activity was due to the c-wrinkled spaces, the needle nanostructures, and also to the hierarchical structure of the Au film and reached 10 times the current density (−5 mA/cm²) achieved by the c-wrinkled film without the needle nanostructures. The large-scale c-wrinkle with confined spaces induced the localized pH near the surface, and the needle nanostructures provided a number of active sites for the reduction reaction. In this manner, the c-wrinkled film serves as an effective template for the CO₂RR catalyst that effects a high local pH which interacts synergistically with the surface needle nanostructures.

It is to be understood that any structural and functional details disclosed herein are not to be interpreted as limiting the systems and methods, but rather are provided as a representative embodiment and/or arrangement for teaching one skilled in the art one or more ways to implement the methods.

It is to be further understood that like numerals in the drawings represent like elements through the several figures, and that not all components and/or steps described and illustrated with reference to the figures are required for all embodiments or arrangements.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to a viewer. Accordingly, no limitations are implied or to be inferred.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

While the invention has been described with reference to exemplary embodiments, it will be understood by those skilled in the art that various changes may be made and equivalents may be substituted for elements thereof without departing from the scope of the invention. In addition, many modifications will be appreciated by those skilled in the art to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A method of fabricating a working electrode adapted for reduction of carbon dioxide comprising:
depositing a gold film (Au) over a shrinkable polymer to create a layered structure;
heating the layered structure at a temperature sufficient to cause shrinking of the polymer; and
removing the polymer layer after shrinking,
wherein the heating creates a contracted wrinkled Au film surface owing to a difference in thermal coefficient between the Au film and the underlaying polymer prior to removal of the polymer, and
wherein the wrinkled film contains a plurality of c-shaped wrinkles having confined spaces adapted to provide an elevated localized pH level.

2. The method of claim 1, further comprising:
controlling a period of the heating step to tune an areal strain (ε=(A₀−A_{f})A₀)) in which A₀ is a total area of the Au film prior to wrinkling and A_{f} is a total area of the Au film after contraction.

3. The method of claim 2, wherein the period of heating is set to produce an areal strain of about 0.5 to about 0.75.

4. The method of claim 1, further comprising forming the Au film over the polymer at a thickness level to set a desired average depth of the plurality of c-shaped wrinkles.

5. The method of claim 4, wherein the Au film is formed at thickness ranging from about 75 nm to about 100 nm.

6. The method of claim 1 further comprising forming needle nanostructures from Au on and within the plurality of c-shaped wrinkles of the Au film.

7. The method of claim 1, further comprising:
before heating, forming an additional sacrificial layer to increase depths of the confined spaces in the plurality of c-shaped wrinkles; and
removing the sacrificial layer.

8. The method of claim 7, wherein the additional sacrificial is formed at between about 4 wt % and 8 wt % of the layered structure.

9. A method of reducing carbon dioxide comprising:
constructing an electrochemical cell containing an electrolyte, a counter electrode and a working electrode formed as a wrinkled Au film containing a plurality of c-shaped wrinkles in c-shaped wrinkles containing confined spaces adapted to provide an elevated localized elevated pH level, and
applying a potential difference across the working electrode and the counter electrode ranging between about −0.25 and about −0.65 Volts,
wherein the potential difference induces a carbon dioxide reduction reaction at the working electrode and to cause the pH level within the confined spaces of the plurality of c-wrinkles to become elevated with respect to a surrounding pH level.

10. The method of claim 9, wherein the Au film of the working electrode has a thickness of about 75 nm to about 100 nm.

11. The method of claim 9, wherein the plurality of c-shaped wrinkles have an average depth range from about 1.8 μm to about 4.2 μm.

12. The method of claim 9, wherein the working electrode has a Faraday efficiency for reducing carbon dioxide of at least 65 percent.

13. The method of claim 12, wherein the working electrode induces a current density for the carbon dioxide reduction reaction of at least 0.05 mA/cm².

14. The method of claim 9, wherein the Au film of working electrode further includes a plurality of needle nanostructures, the plurality of nanostructure having a length ranging from of about 700 nm to about 900 nm.

15. The method of claim 14, wherein the working electrode with added needle nanostructures induces a current density of the carbon dioxide reduction reaction of at least 0.45 mA/cm².

16. A system for reducing carbon dioxide comprising:
an electrolyte;
a counter electrode in contact with the electrolyte;
a working electrode also in contact with the electrolyte, the working electrode formed as a wrinkled Au film containing a plurality of c-shaped wrinkles in c-shaped wrinkles containing confined spaces adapted to provide an elevated localized pH level; and
a voltage source coupled to the counter electrode and working electrode and adapted to generate a potential difference ranging between about −0.25 and about −0.65 Volts therebetween, which induces a carbon dioxide reduction reaction at the working electrode and to cause the pH level within the confined spaces of the plurality of c-wrinkles to become elevated with respect to a surrounding pH level.

17. The system of claim 16, wherein the Au film of the working electrode has a thickness of about 75 nm to about 100 nm.

18. The system of claim 16, wherein the plurality of c-shaped wrinkles have an average depth range from about 1.8 μm to about 4.2 μm.

19. The system of claim 16, wherein the working electrode has a Faraday efficiency for reducing carbon dioxide of at least 65 percent.

20. The system of claim 19, wherein the working electrode induces a current density for the carbon dioxide reduction reaction of at least 0.05 mA/cm².

21. The system of claim 16, wherein the Au film of working electrode further includes a plurality of needle nanostructures, the plurality of nanostructure having a length ranging from of about 700 nm to about 900 nm.

22. The method of claim 21, wherein the working electrode with added needle nanostructures induces a current density of the carbon dioxide reduction reaction of at least 0.45 mA/cm².
